(19) United States
(12) Patent Application Publication
(10) Pub. No.: US 2003/0011309 A1
(43) Pub. Date: Jan. 16, 2003

(54) Mercury vapor arch discharge lamp and method for suppressing leachable mercury formation

(76) Inventors: Deborah Ann Haitko, Schenectady, NY (US); Andrew Peter Blau, Richmond Heights, OH (US); Stanlee Teresa Buddle, Gloversville, NY (US); Bill Kengliem Lui, Gloversville, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/682,041

(22) Filed: Jul. 13, 2001

(51) Int. Cl. H01J 61/36

(52) U.S. Cl. 313/624

(57) ABSTRACT

The formation of leachable mercury upon disposal of a mercury vapor arc discharge lamp is suppressed by fabricating the end caps of the lamp of iron, preferably steel, coated with a nickel-zinc alloy or with tin.

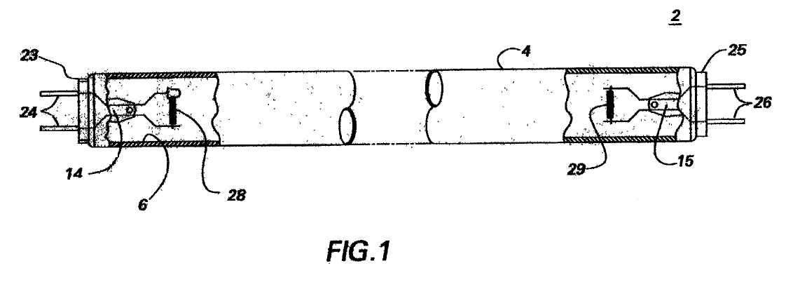

### BACKGROUND OF INVENTION

This invention is directed to arc discharge lamps in which the arc discharge takes place in mercury vapor, including conventional phosphor fluorescent lamps. More particularly, it relates to the avoidance of mercury pollution of landfills and ground water upon disposal of such lamps and during testing for leaching of toxic materials from such lamps and to prevention of the formation of leachable mercury in disposal and testing procedures. The lamps provided herein are characterized by reduced solubilization and leaching of mercury when the lamp is dismantled for testing or upon disposal.

Low pressure mercury vapor arc discharge lamps are standard lighting devices which include electrodes sealed in a glass envelope, the interior of which may be coated with a phosphor. The lamp also contains a small amount of mercury and an inert gas at low pressure, typically about 1 to 5 torr. The term “lamp”, as used herein, means the complete unit including the glass envelope and the end caps and plugs for mounting in a lamp fixture, and wires which connect the internal components of the envelope with the end caps.

During manufacture of fluorescent or low pressure mercury arc lamps, an amount of elemental mercury (Hg) is sealed in the lamp envelope. Most of the mercury adheres to the phosphor coating, a small amount being in the vapor phase.

In operation, alkali metal carbonates from the electrodes decompose and form free oxygen in the lamp. The oxygen may react with a portion of the mercury to form soluble mercury compounds which are leachable from landfills and other disposal facilities to produce a toxic environment. Such compounds include monovalent (mercurous) and divalent (mercuric) mercury compounds.

The Toxicity Leaching Characteristic Procedure (hereinafter sometimes “TLCP”) test is used to determine the proportion of leachable mercury produced upon disposal of such lamps. Soluble mercury compounds formed in the course of the test can detrimental to the accuracy and reliability of the standard test for determination of the leachability of toxic materials from lamp waste. In addition, such compounds can leach into ground water sources, rivers, streams, and the like and constitute toxic materials therein.

U.S. Pat. Nos. 5,949,189 and 5,998,927 describe methods for suppressing the generation of leachable mercury by fabricating lamp parts containing relatively small and relatively large, respectively, proportions of iron; principally elemental iron, but in general any type that can be oxidized to trivalent (ferric) iron. In the former patent, the amount of iron is preferably less than about 1.1 mg per kg of lamp weight; in the latter, at least about 1 g per kg of lamp weight.

It was found that the presence of aluminum end caps on fluorescent lamps can result in the formation of a large level of leachable mercury. While it might be thought that the substitution of iron or steel for aluminum could alleviate this problem, they present their own problems in that oxidation of iron or steel can compromise both the necessary electrical contacts in the lamp and the integrity of the lamp structure which must be retained to preserve the vacuum conditions therein.

It remains of interest, therefore, to develop new means for suppressing the formation of leachable mercury in mercury vapor arc discharge lamps.

### SUMMARY OF INVENTION

The present invention is based on the discovery that the fabrication of mercury vapor arc discharge lamps having end caps of iron coated with specific other metals minimizes the production of leachable mercury upon disposal of such lamps and upon subjection of said lamps in the TCLP test.

One aspect of the invention, therefore, is a method for inhibiting the formation of leachable mercury associated with a mercury vapor arc discharge lamp which comprises fabricating the end caps in said lamp from iron having a coating of nickel-zinc alloy or of tin.

Another aspect of the invention is a mercury vapor arc discharge lamp comprising end caps of iron having a coating of nickel-zinc alloy or of tin.

### BRIEF DESCRIPTION OF DRAWINGS

The drawing is a schematic drawing of a typical mercury vapor arc discharge lamp which is the subject of the present invention.

### DETAILED DESCRIPTION

In order to address the growing concern that excessive amounts of mercury from disposal of fluorescent lamps might leach into surface and subsurface bodies of water, the Environmental Protection Agency has established a maximum concentration level for mercury 200 ppb (by weight) of leachable mercury. The mercury content is generally determined by the standard analysis known as the Toxicity Characteristic Leaching Procedure (TCLP), a well-known test procedure.

In carrying out the TCLP test, the lamps are broken up to form lamp waste material similar to that which would result from lamp disposal in landfills or other disposal locations. The ambient conditions in such locations may promote formation of leachable mercury, just as the TCLP test conditions themselves tend to allow for formation of leachable mercury in amounts greater than the established 200 ppb limit.

It has been found that elemental mercury added to mercury-free pulverized lamp materials prepared for the TCLP test is converted to leachable mercury in the course of the test. If elemental mercury alone or in combination with various glass, phosphor or non-metallic lamp components is tested, little or essentially no leachable mercury is found. However, when elemental mercury is in the presence of metal lamp components, particularly aluminum end caps, it is converted to leachable mercury in substantial amount.

Soluble ions such as ferric and cuprous ions are capable of oxidizing elemental mercury to the monovalent (mercurous) form which is soluble in an acidic aqueous environment and therefore leachable. Moreover, elemental aluminum can form an amalgam with elemental mercury that can undergo further chemistry to produce leachable mercury. According to the present invention, the end caps 23, which are typically of aluminum according to the prior art, are fabricated of iron having a specifically defined coating. When so fabricated, they result in the production of very low levels of leachable mercury. Thus, the invention provides a method for controlling the formation of leachable mercury resulting from oxidation of elemental mercury associated with fluorescent lamps of the mercury vapor discharge type.

The invention provides a mercury vapor discharge lamp comprising an envelope of light-transmitting glass which contains an inert gas and an amount of elemental mercury, and a pair of electrodes for establishing an arc discharge. The lamp further comprises at least one coated iron end cap which defines a cavity having an inner surface, and which is secured to the lamp envelope by a basing cement. Generally, such lamps have a pair of end caps, typically of a thickness on the order of 100-500 microns.

Referring to the drawing, it will be seen that an illustrative fluorescent lamp 2 includes first and second electrodes 28, 29 extending, respectively, from first and second electrode mounts 14, 15 at opposite ends of an elongated glass envelope 4, the interior surface of which is coated with a layer of phosphor 6. The envelope 4 further contains a quantity of an ionizable medium, typically mercury. The envelope 4 still further contains 1a starting gas, usually one or more of argon, neon, helium, krypton and xenon. End caps 23, 25 bearing connection pins 24, 26 are placed on the ends of envelope 4.

The particular coatings for the iron end caps which have been found effective to minimize the formation of leachable mercury are fabricated of nickel-zinc alloys and of tin. Iron, particularly steel, having such coatings is commercially available. For the most part, the coating is on the order of 1-10 microns in thickness. With regard to nickel-zinc alloy coatings, the ones which are suitable typically comprise about 5-25%, preferably about 5-15%, nickel by weight with the balance being zinc.

It should be noted that not all coatings of other metals on iron provide the advantageous properties observed according to the present invention. For example, the use of nickel-coated iron and iron coated with a combination of tin and nickel for the fabrication of end caps results in leachable mercury formation to a much greater degree than the use of tin-coated or nickel-zinc alloy-coated iron.

In an example of the present invention, a 1.5-inch fluorescent lamp having conventional aluminum end caps was found, at mercury contents of 5, 10, 15 and 20 mg, to afford leachable mercury in the TCLP test on the order of 110, 250, 375 and 740 ppb, respectively. By contrast, a similar lamp in which the end caps were of steel (254 microns thick) coated with a 1.9-micron coating of nickel-zinc (about 10% nickel by weight) afforded leachable mercury on the order of 50, 80, 150 and 190 ppb, respectively. Similarly, a 1.5-inch lamp having end caps (152 microns thick) of steel coated with about 1.9 microns of cold rolled tin afforded, at a mercury content of 20 mg, leachable mercury in the amount of 39 ppb. From these results, the advantage of employing iron end caps coated with nickel-zinc alloy or tin is apparent.

1. A method for inhibiting the formation of leachable mercury associated with a mercury vapor arc discharge lamp which comprises fabricating the end caps in said lamp from iron having a coating of nickel-zinc alloy or of tin.

2. A method according to claim 1 wherein the iron is steel.

3. A method according to claim 1 wherein the coating is of nickel-zinc alloy.

4. A method according to claim 3 wherein the nickel-zinc alloy comprises about 5-25% nickel by weight with the balance being zinc.

5. A method according to claim 1 wherein the coating is of tin.

6. A method according to claim 1 wherein the thickness of the end caps is about 100-500 microns.

7. A method according to claim 6 wherein the thickness of the coating is about 1-10 microns.

8. A method for inhibiting the formation of leachable mercury associated with a mercury vapor arc discharge lamp which comprises fabricating the end caps in said lamp from steel having a coating of nickel-zinc alloy or of tin, said end caps being about 100-500 microns thick and said coating being about 1-10 microns thick.

9. A mercury vapor arc discharge lamp comprising end caps of iron having a coating of nickel-zinc alloy or of tin.

10. A lamp according to claim 9 wherein the iron is steel.

11. A lamp according to claim 9 wherein the coating is of nickel-zinc alloy.

12. A lamp according to claim 11 wherein the nickel-zinc alloy comprises about 5-25% nickel by weight with the balance being zinc.

13. A lamp according to claim 9 wherein the coating is of tin.

14. A lamp according to claim 9 wherein the thickness of the end caps is about 100-500 microns.

15. A lamp according to claim 14 wherein the thickness of the coating is about 1-10 microns.

16. A mercury vapor arc discharge lamp comprising end caps of steel having a coating of nickel-zinc alloy or of tin, said end caps being about 100-500 microns thick and said coating being about 1-10 microns thick.
